(19) United States
(12) Patent Application Publication
(10) Pub. No.: US 2026/0312795 A1
(43) Pub. Date: Oct. 8, 2026

(54) NONLOCALLY RANDOMIZED QUANTUM-AUGMENTED SECURITY

(71) Applicant: QUNNECT, INC., Brooklyn, NY (US)

(72) Inventors: Mehdi Namazi, Brooklyn, NY (US); Alexander Craddock, Brooklyn, NY (US); Anne Lazenby, Brooklyn, NY (US); Mael Flament, Brooklyn, NY (US)

(73) Assignee: QUNNECT, INC., Brooklyn, NY (US)

(21) Appl. No.: 19/483,171

(22) PCT Filed: May 24, 2024
(86) PCT No.: PCT/US2024/031076

§ 371 Date: Nov. 10, 2025

Related U.S. Application Data
(60) Provisional application No. 63/504,427, filed on May 25, 2023.

(51) Int. Cl. H04L 9/08; G06F 7/58; H04B 10/70

(52) U.S. Cl. CPC H04L 9/0852; G06F 7/588; H04B 10/70

(57) ABSTRACT

The inventors have developed methods and systems to address the above challenges using entangled photons with multiple colors transmitted with a classical data stream as a technique to detect eavesdropping on the data stream and to prevent reverse engineering for demodulating the entangled bits from the data stream. In some embodiments, a time gate is used to interleave the quantum and classic signals to provide quantum encryption of fiber optic communication protocols.

### CROSS REFERENCE TO RELATED APPLICATIONS

This application claims the benefit of priority under 35 U.S.C. § 119(e) to U.S. Provisional Patent Application Ser. No. 63/504,427, filed on May 25, 2023, and entitled “NONLOCALLY RANDOMIZED QUANTUM-AUGMENTED SECURITY (NORAQUS),” under Attorney Docket No. Q0074.70016US00 which is incorporated by reference herein in its entirety.

### BACKGROUND

Quantum networks facilitate the transmission of information in the form of quantum bits (“qubits”) between physically separated quantum processors or other quantum devices (e.g., quantum sensors). Quantum networks may be used to enable optical quantum communication over distances and can be implemented over standard telecommunication optical fibers through the transmission of single photons onto which information is encoded (e.g., in polarization). To enable the reliable transmission of quantum information over any distance, additional components may be needed.

### SUMMARY

The following is a non-limiting summary of some embodiments of the present application. Some aspects of the present application are directed to a system for encrypting a data stream, the system comprising: an encryption channel comprising an optical fiber; a first photon source configured to, during operation of the system, generate a first pair of entangled photons comprising a first photon and a second photon, wherein the first photon source is configured to output the first photon to the encryption channel and to output the second photon to a time gate; a second photon source configured to, during operation of the system, generate a second pair of entangled photons comprising a third photon and a fourth photon, wherein the second photon source is configured to output the third photon to the encryption channel and to output the fourth photon to a bell state evaluator; an optical modulator configured to modulate a photon to generate an encoded photon for transmission of the data stream; and the time gate is configured to, responsive to receiving the second photon, cause the third photon or the encoded photon for the transmission of the data stream to be output to the encryption channel.

In some embodiments, the optical fiber of the encryption channel is configured to transmit light having a telecom wavelength.

In some embodiments, the optical fiber of the encryption channel is configured for bidirectional transmission.

In some embodiments, the optical fiber of the encryption channel is a first optical fiber that is configured for unidirectional transmission and wherein the encryption channel further comprises one or more optical fibers, the one or more optical fibers comprising a second optical fiber that is configured for unidirectional transmission is a direction opposite to the direction of transmission of the first optical fiber.

In some embodiments, the time gate is an optical switch.

In some embodiments, the first entanglement light source is an atomic vapor cell-based entanglement source configured to produce a pair of entangled photons having different wavelengths.

In some embodiments, a first entangled photon of the pair of entangled photons has a wavelength between 1200 and 1600 nm, and the second entangled photon of the pair of entangled photons has a wavelength between 700 and 900 nm.

In some embodiments, the first entangled photon has a wavelength of 1529 nm and the second entangled photon has a wavelength of 780 nm.

In some embodiments, a quantum random number generator is used to generate the gating signal to control the time gate.

In some embodiments, the quantum random number generator is configured to detect light having a polarization corresponding to the polarization state of the second entangled photon.

In some embodiments, the quantum random number generator is configured to transmit a control signal to the time gate based on the polarization state of the second entangled photon.

In some embodiments, the time gate is configured to transmit light received from the optical modulator in response to the quantum random number generator detecting an entangled photon having a first polarization state, and the time gate is configured to transmit light received from the second entanglement source in response to the quantum random number generator detecting an entangled photon having a second polarization state where the second polarization state is orthogonal to the first polarization state.

In some embodiments, the first entanglement light source is configured to generate a first entangled photon and a second entangled photon, the first entangled photon having a wavelength in the C-band, and the second entanglement light source is configured to generate a third entangled photon and a fourth entangled photon, the third entangled photon having a wavelength in the O-band.

In some embodiments, the optical modulator is configured to modulate light having a same wavelength as the third entangled photon.

Some aspects of the present application are directed to a system for reading an encrypted signal from a telecom data stream, the system comprising: an encryption channel comprising an optical fiber; a first photon detector configured to receive a first entangled photon to generate a gating signal to control a time gate; the time gate comprising two or more outputs, and the time gate being configured to control which one of the two or more outputs to send a signal received from the optical fiber at an input of the time gate; a second photon detector configured to receive output from a first output of the time gate and to determine an entanglement state of the photon; and a third photon detector configured to receive output from a second output of the time gate and to detect photons corresponding to a data stream.

In some embodiments, the optical fiber of the encryption channel is configured to transmit light having a telecom wavelength.

In some embodiments, the optical fiber of the encryption channel is configured for bidirectional transmission.

In some embodiments, the optical fiber of the encryption channel is a first optical fiber that is configured for unidirectional transmission and wherein the encryption channel further comprises one or more optical fibers, the one or more optical fibers comprising a second optical fiber that is configured for unidirectional transmission is a direction opposite to the direction of transmission of the first optical fiber.

In some embodiments, the time gate is an optical switch.

In some embodiments, the first photon detector is coupled to a quantum random number generator that is configured to generate the gating signal to control the time gate based at least in part on the output of the photon detector.

In some embodiments, the first photon detector is configured to detect light having a polarization corresponding to the polarization state of the first entangled photon.

In some embodiments, the quantum random number generator is configured to transmit a control signal to the time gate based on the polarization state of the second entangled photon.

In some embodiments, the time gate is configured to transmit light received from the optical fiber to the second photon detector in response to the output of the quantum random number generator detecting an entangled photon having a first polarization state, and the time gate is configured to transmit light received from the optical fiber to the third photon detector in response to the quantum random number generator detecting an entangled photon having a second polarization state where the second polarization state is orthogonal to the first polarization state.

In some embodiments, an unencrypted channel.

In some embodiments, the output of the second photon detector and the unencrypted channel are configured for verifying the security of the encrypted channel.

Some aspects of the present application are directed to a system for processing encrypted signals in a telecom data stream, the system comprising: an encryption channel comprising an optical fiber; a time gate comprising two or more inputs and two or more outputs to direct incoming and outgoing photons; an optical modulator configured to modulate photons corresponding to a data stream to generate encoded photons for transmission; a first photon source configured to generate a first pair of entangled photons, the first entanglement light source being configured to provide a first photon, of the first pair of entangled photons, to the encryption channel and to provide a second photon, of the first pair of entangled photons, to a bell state evaluator; and a first photon detector configured to receive a first entangled photon to generate a gating signal to control the time gate.

In some embodiments, the optical fiber of the encryption channel is configured to transmit light having a telecom wavelength.

In some embodiments, the optical fiber of the encryption channel is configured for bidirectional transmission.

In some embodiments, the optical fiber of the encryption channel is a first optical fiber that is configured for unidirectional transmission and wherein the encryption channel further comprises one or more optical fibers, the one or more optical fibers comprising a second optical fiber that is configured for unidirectional transmission is a direction opposite to the direction of transmission of the first optical fiber.

In some embodiments, the time gate is an optical switch.

In some embodiments, the first photon detector is configured to detect light having a polarization corresponding to the polarization state of the first entangled photon.

In some embodiments, the first photon detector is configured with a random number generator that is configured to transmit a control signal to the time gate based on the polarization state of the first entangled photon.

In some embodiments, the time gate is configured to transmit light received from the optical modulator in response to the quantum random number generator detecting an entangled photon having a first polarization state, and the time gate is configured to transmit light received from the second entanglement source in response to the quantum random number generator detecting an entangled photon having a second polarization state where the second polarization state is orthogonal to the first polarization state.

In some embodiments, the first photon source is configured to generate at least one entangled photon having a same wavelength as photons produced by the optical modulator.

Some aspects of the present application are directed to a method for encrypting telecom optical signals using optical qubits for secure communication transmission, the method comprising: generating a gating signal based on a coherent photon received by a detector of a quantum random number generator; generating a first bichromatic entangled pair comprising a first photon with a first wavelength configured for telecom transmission and a second photon having a second wavelength that is different than the first wavelength; selecting whether to transmit an optical source encoded for data transmission or the first photon through an encryption channel, the selection being based on the random number; and detecting a state of the second photon.

In some embodiments, the encryption channel is an optical fiber configured to transmit light having a telecom wavelength.

In some embodiments, selecting whether to transmit the optical source encoded for data transmission or the first photon through the encryption channel comprises controlling which input of an optical switch is output by the switch.

In some embodiments, generating the first bichromatic entanglement pair comprises generating the entangled pair of photons using a two-photon pumping of an atomic vapor cell.

In some embodiments, the method further comprises, prior to generating the gating signal, generating the coherent photon by generating a second bichromatic entanglement pair.

In some embodiments, detecting the state of the second photon comprises detecting a polarization state of the second photon.

In some embodiments, the method further comprises receiving, through a non-quantum encrypted channel, an indication of the polarization state of the first photon; and determining whether the polarization state of the first photon and the polarization state of the second photon indicate that the first photon and the second photon remained entangled after transmission of the first photon through the encryption channel.

In some embodiments, the method further comprises receiving, through a non-quantum encrypted channel, an indication of when the first photon was received after transmission through the encryption channel; determining whether a transmitted photon is missing based on the received indication of when the first photon was received after transmission through the encryption channel and an indication of when the first photon was transmitted through the encryption channel.

Some aspects of the present application are directed to a method for decoding an optical signal that is encoded with optical qubits to receive a data stream, the method comprising: generating a gating signal based on a coherent photon received by a detector of a quantum random number generator; selecting whether to transmit a received photon to a first optical detector or a second optical detector based on the random number; detecting a photon corresponding to an entangled photon received at the first optical detector; determining an entanglement state of the photon received at the first optical detector; and detecting a second photon corresponding to a data stream received at the second optical detector.

In some embodiments, the coherent photon received by the detector is received from an encryption channel, and wherein the encryption channel an optical fiber configured to transmit light having a telecom wavelength.

In some embodiments, selecting whether to transmit the received photon to the first optical detector or to the second optical detector comprises controlling which output of an optical switch to transmit the received photon through.

In some embodiments, detecting the photon corresponding to the entangled photon comprises detecting a polarization state corresponding to the polarization state of the photon received at the first optical detector.

In some embodiments, the method further comprises transmitting, through a non-quantum encrypted channel, an indication of the polarization state of the photon received at the first optical detector.

In some embodiments, the method further comprises transmitting, through a non-quantum encrypted channel an indication of when the photon was received at the first optical detector.

### BRIEF DESCRIPTION OF DRAWINGS

FIG. 1 illustrates a block diagram of a quantum encryption system, in accordance with some embodiments of the technology described herein.

FIG. 2A illustrates a method for transmitting quantum encrypted signals, in accordance with some embodiments of the technology described herein.

FIG. 2B illustrates a method for decoding a received quantum encrypted signal, in accordance with some embodiments of the technology described herein.

FIG. 3 illustrates a block diagram of a quantum encryption system for sending and receiving quantum encrypted signals, in accordance with some embodiments of the technology described herein.

FIG. 4 illustrates a block diagram of an alternative configuration of a quantum encryption system for sending and receiving quantum encrypted signals, in accordance with some embodiments of the technology described herein.

FIG. 5 illustrates a schematic diagram of a quantum encryption system for sending and receiving quantum encrypted signals, in accordance with some embodiments of the technology described herein.

### DETAILED DESCRIPTION

The inventors have developed techniques to facilitate quantum information science by developing protocols to facilitate quantum encryption of non-quantum data transmission infrastructure such that the versatile implementation of non-quantum data transmission protocols may be modified by quantum encryption protocols to enhance the security of data transmission against an attacker that may try to intercept or copy the transmitted signals.

Quantum entanglement distribution is commonly seen as the most viable tool for scalable quantum networks that aim towards distributed quantum computing, sensing, and secure communication. There have been many protocols and demonstrations about the latter application proving the advantage of using entanglement for secret key sharing compared to the most commonly used methods of quantum key exchanges. Most of these protocols are focused on the problems arising from the advancement of quantum computers and the vulnerability of public key exchanges from these attacks. However, what is commonly ignored is the potential application of quantum entanglement in protecting classical channels of communication to prevent attacks that are already of concern today.

The inventors have appreciated that augmenting classical channels with quantum entanglement brings forth the possibility of near-time threat of intrusion detection. The enhancement provides two users on opposite ends of a communication system with a method to verify whether any intruder is listening to, coping or rerouting the cipher texts during their transmission. Such a protocol could bring the threat detection time to shorter than a second.

The inventors have recognized that there are several challenges to implementing a quantum entanglement protocol for threat detection on a classical communication channel. A first challenge is that users of the communication system would need a publicly known protocol to leverage the correlation between photons to enhance the security of their classical channel without allowing third parties to listen and reroute the classical data absent disrupting the quantum entanglement. A second challenge is that there is a need for quantum hardware compatible with classic telecom infrastructure that is also capable of producing and maintaining high rates of pure entangled pairs. In addition to augmenting existing classical infrastructure, the quantum hardware could further expand distributed quantum computing and secure network infrastructure. A third challenge is the integration of the quantum hardware into complex multi-node networks for delivering entangled photons across the telecom network.

The inventors have developed methods and systems to address the above challenges using entangled photons with multiple colors transmitted with a classical data stream as a technique to detect eavesdropping on the data stream and to prevent reverse engineering for demodulating the entangled bits from the data stream.

The inventors have developed a system for encrypting a data stream, the system comprising: an encryption channel comprising an optical fiber; a first photon source configured to, during operation of the system, generate a first pair of entangled photons comprising a first photon and a second photon, wherein the first photon source is configured to output the first photon to the encryption channel and to output the second photon to a time gate; a second photon source configured to, during operation of the system, generate a second pair of entangled photons comprising a third photon and a fourth photon, wherein the second photon source is configured to output the third photon to the encryption channel and to output the fourth photon to a bell state evaluator; an optical modulator configured to modulate a photon to generate an encoded photon for transmission of the data stream; and the time gate is configured to, responsive to receiving the second photon, cause the third photon or the encoded photon for the transmission of the data stream to be output to the encryption channel.

The inventors have developed a system for reading an encrypted signal from a telecom data stream, the system comprising: an encryption channel comprising an optical fiber; a first photon detector configured to receive a first entangled photon to generate a gating signal to control a time gate; the time gate comprising two or more outputs, and the time gate being configured to control which one of the two or more outputs to send a signal received from the optical fiber at an input of the time gate; a second photon detector configured to receive output from a first output of the time gate and to determine an entanglement state of the photon; and a third photon detector configured to receive output from a second output of the time gate and to detect photons corresponding to a data stream.

The inventors have developed a system for processing encrypted signals in a telecom data stream, the system comprising: an encryption channel comprising an optical fiber; a time gate comprising two or more inputs and two or more outputs to direct incoming and outgoing photons; an optical modulator configured to modulate photons corresponding to a data stream to generate encoded photons for transmission; a first photon source configured to generate a first pair of entangled photons, the first entanglement light source being configured to provide a first photon, of the first pair of entangled photons, to the encryption channel and to provide a second photon, of the first pair of entangled photons, to a bell state evaluator; and a first photon detector configured to receive a first entangled photon to generate a gating signal to control the time gate.

The inventors have developed a method for encrypting telecom optical signals using optical qubits for secure communication transmission, the method comprising: generating a gating signal based on a coherent photon received by a detector of a quantum random number generator; generating a first bichromatic entangled pair comprising a first photon with a first wavelength configured for telecom transmission and a second photon having a second wavelength that is different than the first wavelength; selecting whether to transmit an optical source encoded for data transmission or the first photon through an encryption channel, the selection being based on the random number; and detecting a state of the second photon.

The inventors have developed a method for decoding an optical signal that is encoded with optical qubits to receive a data stream, the method comprising: generating a gating signal based on a coherent photon received by a detector of a quantum random number generator; selecting whether to transmit a received photon to a first optical detector or a second optical detector based on the random number; detecting a photon corresponding to an entangled photon received at the first optical detector; determining an entanglement state of the photon received at the first optical detector; and detecting a second photon corresponding to a data stream received at the second optical detector.

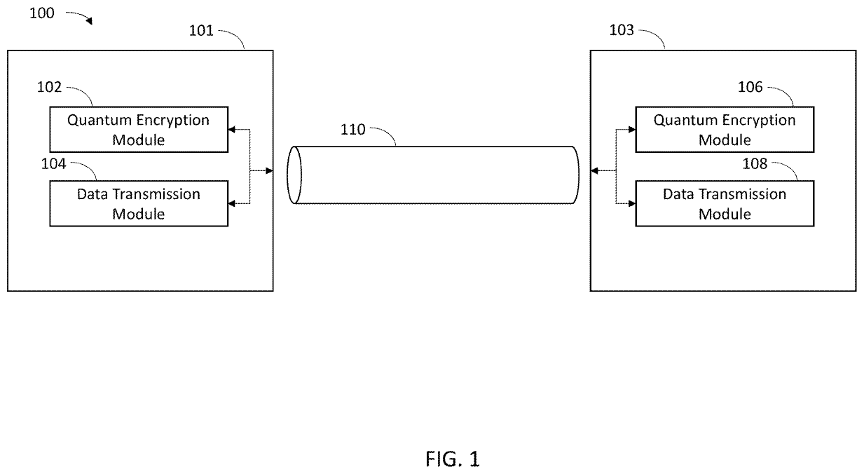

FIG. 1 illustrates a block diagram of a quantum encryption system 100, in accordance with some embodiments of the technology described herein. Quantum encryption system 100 includes two communication nodes, communication node 101 and communication node 103. Communication nodes are network connection points that are communicatively linked through transmission lines such that data transmissions may be sent and received between the nodes. Communication node 101 and communication node 103 are communicatively linked through transmission line 110.

Transmission line 110 is an optical fiber configured as an encryption channel for communicatively coupling communication node 103 and communication 101. In some embodiments, the optical fiber of the encryption channel is configured to transmit light having a telecom wavelength, as described herein. In some embodiments, the optical fiber of the encryption channel is configured for bidirectional transmission. In some embodiments, the optical fiber of the encryption channel is a first optical fiber that is configured for unidirectional transmission and wherein the encryption channel further comprises one or more optical fibers, the one or more optical fibers including a second optical fiber that is configured for unidirectional transmission is a direction opposite to the direction of transmission of the first optical fiber.

In some embodiments, a single optical fiber may be used for bidirectional data transmission. In some embodiments, bidirectional data transmission over a single optical fiber may include using different transmission wavelengths for each direction of the transmission or scheduling transmission within particular time windows such that transmitted pulses are not being simultaneously transmitted and received at the same time.

Transmission line 110 may be any optical fiber compatible with the wavelengths of transmission which depend, at least in part, on the entanglement light source and the corresponding wavelengths which may be produced by the light source. Accordingly, any material capable of low loss transmission of photons for the length of fiber corresponding to the distance between the communication nodes may be used. Examples of entanglement light sources and their corresponding wavelengths of operation are provided below in Table 1 and Table 2.

Communication node 101 includes quantum encryption module 102 and data transmission module 104. Quantum encryption module 102 is configured to generate entangled quantum states. Data transmission module 104 is configured to generate signals encoded with bits representative of data to be transmitted between nodes of a network. The communication node 101 is configured to encrypt transmissions to be sent through transmission line 110 such that entangled quantum states generated by quantum encryption module 102 are transmitted along with the encoded signals generated by data transmission module 104.

In some embodiments, data transmission module 104 includes a modulatable light source for generating photons which are modulated in accordance with a fiber optic data transmission protocol. In some embodiments, data transmission module 104 includes a light source and a light modulator. The light source may be a coherent light source such as a laser to provide coherent light to the light modulator. The light modulator may receive data for encoding and may modulate the light received from the light source in accordance with the received data for encoding.

Quantum encryption module 102 includes an entanglement source based on an atomic vapor cell to produce a pair of entangled photons. In some embodiments, the quantum encryption module produces a pair of entangled photons having different wavelengths, as described herein. In some embodiments, the pair of entangled photons are entangled in the polarization space. To facilitate encryption, the quantum encryption module 102 analyzes one of the entangled photons locally to determine the state of the entangled attribute. For example, for photons entangled in the polarization space, the quantum encryption module detects the polarization state of one of the entangled photons and provides the other entangled photon from the entangled pair to communication node 101 for transmission. In some embodiments, the photons may be entangled in a different attribute space, as aspects of the technology described herein are not limited in this respect.

In some embodiments, communication node 101 encrypts transmissions by interleaving entangled photons generated by the quantum encryption module 102 with photons encoded with data generated by data transmission module 104. For example, the interleaving of entangled photons and data encoded photons results in a temporal variation between transmitting entangled photons and data photons through transmission line 110. The temporal interleaving of photons for transmission results in entangled photons being interleaved between data encoded photons. Through the interleaving of entangled photons with data encoded photons, a potential attack can be identified by detecting the collapse of the entangled state. To prevent a potential attacker from intercepting the interleaved signal and attempting to eavesdrop on only the data encoded photons while leaving the entangled photons unperturbed, the ordering of the interleaving is randomized in accordance with the encryption protocol.

In some embodiments, the transmission line 110 includes a channel fidelity device to compensate for the polarization drift that occurs during transmission through the fiber. Accordingly, the polarization drift that may cause artifacts in the subsequent determination of polarization state of photons transmitted through the transmission line can be compensated for, increasing signal fidelity.

Communication node 103 receives the encrypted transmissions from communication node 101 through transmission line 110. Communication node 103 is configured to decode the encrypted transmissions by forwarding entangled photons to the quantum encryption module 106 and sending data encoded photons to data transmission module 108. To facilitate the proper forwarding of the entangled photons and the data encoded photons, an additional time gating signal is sent through the entangled transmission line. In some embodiments, the time gating signal is a second entangled photon produced as part of a second entangled pair generated by the quantum encryption module. Accordingly, the second entangled pair may be used both by communication node 101 to determine the interleaving of signals together and the corresponding entangled photon of the second entangled pair may be used by communication node 103 to generate a gating signal to separate the respective signals to the appropriate module.

To monitor the security of the encrypted transmission, quantum encryption module 102 and quantum encryption module 106 exchange information measured at each module, corresponding to the state of the entangled photons. When the entanglement is preserved, the data exchange between the communication nodes is confirmed to be secure. However, where the entanglement is not preserved, the security of data exchange may be compromised. In some embodiments, quantum encryption module 102 and quantum encryption module 106 execute Bell state measurements to determine Bell state values for the entangled photons. The quantum encryption modules may then exchange Bell state values by sending the Bell state value measured at the receiving quantum encryption module back to the transmitting quantum encryption module to monitor the entanglement between the two communication nodes involved in the communicative transmission. In some embodiments, the exchange of Bell state values may occur through an unencrypted channel separate from transmission line 110.

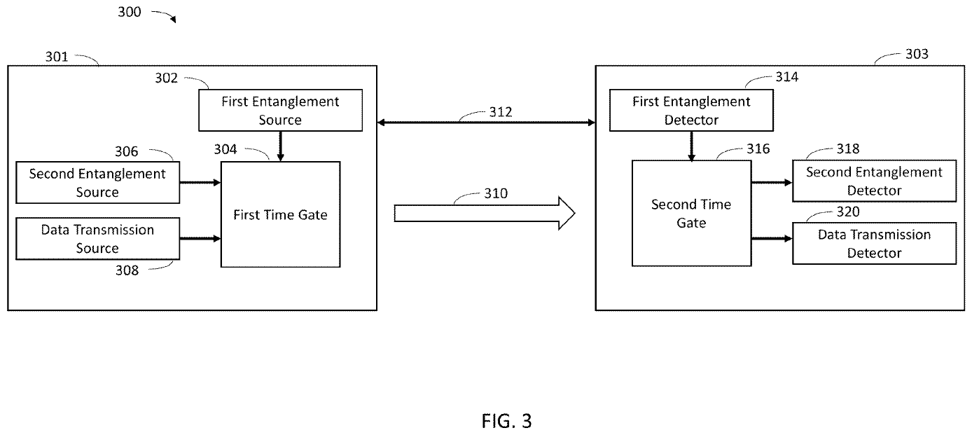

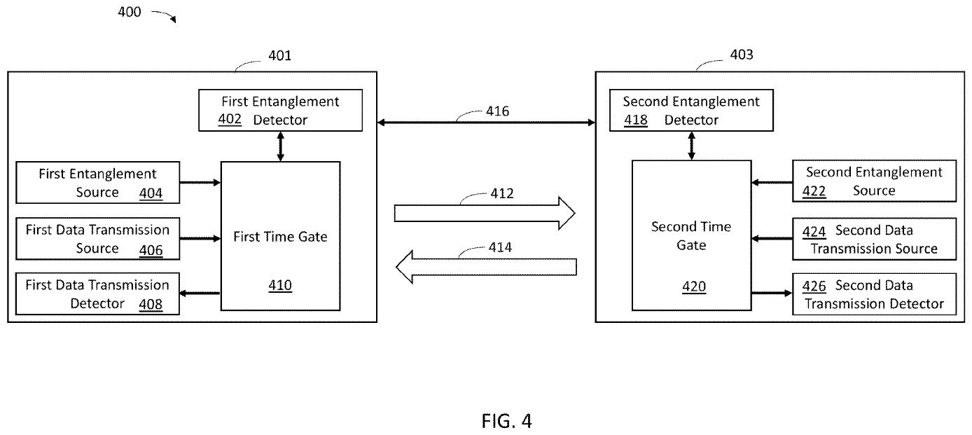

In some embodiments, quantum encryption module 102 and quantum encryption module 106 are configured in the same way, and data transmission module 104 and data transmission module 108 are configured in the same way such that communication node 101 and communication node 103 may each send and receive signals to one another, as described further below in connection with FIGS. 3 and 4.

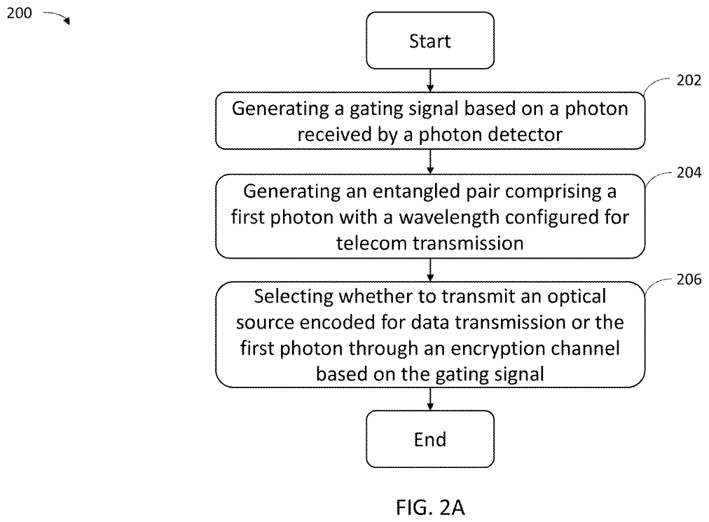

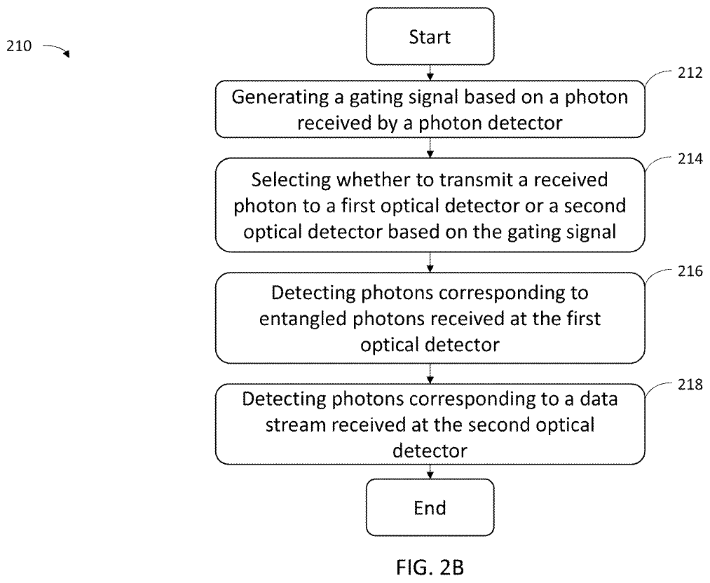

FIG. 2A illustrates a method 200 for transmitting quantum encrypted signals, in accordance with some embodiments of the technology described herein. Prior to the start of method 200, a first photon source generates a pair of entangled photons for use in generating gating signals for the encoding and decoding of the data transmission. One of the entangled photons is detected locally to generate a gating signal at one communication node involved in the transmission and the other entangled photon is transmitted to the corresponding communication node of the transmission to generate a corresponding gating signal. In some embodiments, the first photon source is configured on the transmitting side of the communication. Accordingly, one of the entangled photons is detected at the transmission node and used to generate a gating signal for the encryption. The second entangled photon is transmitted to the corresponding receiving node where it is used to generate a gating signal for the decryption. In some embodiments, the first photon source is configured on the receiving side of the communication. Accordingly, one of the entangled photons is detected at the receiving node and used to generate a gating signal for the decryption. The second entangled photon is transmitted to the corresponding transmitting node where it is used to generate a gating signal for the decryption.

Method 200 starts at act 202 by generating a gating signal based on a photon received by a photon detector, in accordance with some embodiments of the technology described herein. The photon received by the photon detector is an entangled photon generated by the first entangled photon source. In some embodiments, the entanglement is an entanglement in the polarization space. Therefore, the gating signal is generated based on the polarization of the detected photon. The gating signal may have a first value for a first polarization and a second value for a second polarization, the second polarization being orthogonal to the first polarization.

Next, method 200 continues at act 204 by generating an entangled pair comprising a first photon with a wavelength configured for telecom transmission, in accordance with some embodiments of the technology described herein. A second light source generates a second entanglement pair. In some embodiments, the second light source generates an entanglement pair having different wavelengths. At least one of the entangled photons has a wavelength in the telecom range, as described herein.

Next, method 200 continues at act 206, by selecting whether to transmit an optical source encoded for data transmission or to transmit the first photon through an encryption channel based on the gating signal, in accordance with some embodiments of the technology described herein. The optical source encoded for data transmission generates a modulated optical signal corresponding to bits for data transmission, as described herein. The selection of whether to transmit an optical source encoded for data transmission or to transmit the first photon through an encryption channel based on the gating signal may include using the gating signal to control an optical switch. The optical switch may include two inputs, one input which receives entangled photons from the second photon source and a second input which receives photons encoded with data for transmission. Based on the gating signal, one value of the gating signal causes the optical switch to cause the photons received at the first input to be transmitted from the output of the optical switch to the encryption channel. The other value of the gating signal causes the optical switch to cause the photons received at the second input to be transmitted from the output of the optical switch to the encryption channel. As the gating signal varies in time, according to the random polarization of the photons produced from the first light source, the output of the optical switch varies between the two inputs. Thus, the output of the optical switch, and the signal, which is transmitted through the encryption channel, is a time interleaved transmission between the photons encoded for data transmission and the entangled photons.

Following act 206, method 200 concludes. Following the conclusion of the transmission of a quantum encrypted signal, a method for decrypting the signal or for reading out the data encoded in the photons may be used. In some embodiments, following the conclusion of method 200, an indication of when the entangled photons, transmitted by the time gate through the encryption channel, are detected at the receiving node. Based on the indication of when the entangled photons are received and the receiving node and an indication of when the time gate transmits an entangled photon, rather than a data photon, the two indications may be compared to determine whether any photons were lost in transmission and did not get received at the receiving node. Such a determination that photons are missing may be an indication that the encryption channel is compromised. The indication of when photons were received at the receiving device may be transmitted to the transmitting device through a non-quantum encrypted transmission line.

FIG. 2B illustrates a method 210 for decoding a received quantum encrypted signal, in accordance with some embodiments of the technology described herein. Prior to the start of method 210, the quantum encrypted signal may be generated in accordance with an encryption method, such as method 200 described above.

Method 210 starts at act 212 by generating a gating signal based on a photon received by a photon detector, in accordance with some embodiments of the technology described herein. As described above in connection with FIG. 2A, a first entanglement source may generate two entangled photons, one of which is used at the transmitting node to encode the transmission and the other is used at the receiving node to decode the transmission. Accordingly, the gating signal is generated based on an entangled photon from the first entanglement source, as described herein.

Next, method 210 continues at act 214 by selecting whether to transmit a receiving photon to a first optical detector or a second optical detector based on the gating signal, in accordance with some embodiments of the technology described herein. The selection may be facilitated by an optical switch having an input for receiving the encoded signal and two outputs. A first output of the optical switch transmits light to an entanglement detector for determining Bell state values associated with the entangled photons. A second output of the optical switch transmits light to an optical detector for detecting the photon and decoding the encoded data represented therein. In some embodiments, the gating signal has a first value, based on a polarization of the entangled photon from the first entanglement source, that causes the optical gate to output received photons to the entanglement detector. Additionally, the gating signal has a second value that causes the optical gate to output received photons to the optical detector for decoding the data transmission.

Next, method 210 continues at act 216 by detecting photons corresponding to entangled photons received at the first optical detector, in accordance with some embodiments of the technology described herein. In some embodiments, the first optical detector is configured as a Bell state value detector. The Bell state value detector includes a photon detector and polarization optics selected for a particular polarization to be received by the photon detector such that Bell state values may be determined.

Once detected, the polarization state information about the received photon is transmitted through non-quantum encrypted channels to use with the polarization state information detected for the corresponding entangled photon to determine whether or not the entanglement has been preserved and by extension, whether the encryption remains secure.

Next, method 210 continues at act 208 by detecting photons corresponding to a data stream received at the second optical detector, in accordance with some embodiments of the technology described herein. The encoded photons are provided to a photon detector to detect the photons and to determine the decoded data signals such as to receive the data transmitted from the transmission node.

Following act 208, method 210 concludes. Following the conclusions of method 210, the methods may be repeated such that additional data is transmitted between the communication nodes. In some embodiments, following method 210, an indication of when entangled photons were received at the Bell state value detector may be transmitted to a transmitting device such through a non-quantum encrypted channel such that the transmitting device may determine whether any transmitted entangled photons failed to be received.

FIG. 3 illustrates a block diagram of a quantum encryption system 300 for sending and receiving quantum encrypted signals, in accordance with some embodiments of the technology described herein. Quantum encryption system 300 includes two communication nodes, communication node 301 and communication node 303. Communication node 301 includes first entanglement source 302, second entanglement source 306, data transmission source 308 and first time gate 304. Communication node 303 includes first entanglement detector 314, second entanglement detector 318, data transmission detector 320, and second time gate 316. Transmission line 310 is configured to transmit encrypted signals from communication node 301 to communication node 303. Additional communication line 312 is configured for sending and/or receiving signals which are not quantum encrypted between the communication nodes.

First entanglement source is a first photon source configured to generate a first pair of entangled photons during operation of system 300. The first pair of entangled photons includes a first photon and a second photon. The first photon source is configured to output the first photon to the encryption channel 310 and to output the second photon to the first time gate 304.

First entanglement source 302 may be any suitable entanglement source for producing entangled photons that include at least one photon having a wavelength that coincides with telecom applications. Wavelengths used in telecom applications are classified into different bands of wavelengths. Two commonly used bands for telecom applications are the O-band and the C-band. The O-band covers approximately 1260 nm to 1360 nm. The C-band covers approximately 1530 nm to 1565 nm. In some embodiments, the first entanglement source 302 generates a first entangled photon in the C-band and a second entangled photon in the Near IR range (e.g., approximately 800 nm to 2,500 nm).

In some embodiments, the first entanglement source includes an atomic vapor cell and one or more lasers configured for two-photon pumping to generate entangled polarization states in a three-level atomic system. In some embodiments, the atomic vapor cell may contain an atomic vapor comprising atoms that may, upon receipt of pump fields (e.g., laser beams) absorb received photons of certain frequencies, go through a two-stage excitation and decay process, and re-emit photons having entangled polarization states. For example, the atomic vapor cell may contain an atomic vapor of rubidium (e.g., ⁸⁷Rb, ⁸⁵Rb, or any other suitable isotope). Alternatively, in some embodiments, the atomic vapor cell may contain an atomic vapor of another alkali metal. For example, the alkali metal may include isotopes of cesium (e.g., ¹³³Cs, or any other suitable isotope).

In some embodiments, the atomic vapor may exhibit a two-photon resonance that permits generation of entangled photon pairs at two desired wavelengths. For example, ⁸⁷Rb exhibits a two-photon resonance (or four-wave mixing process) along the transitions |5S_{1/2} [symbol] →|5P_{3/2} [symbol] →6S_{1/2} [symbol] which can generate entangled photons having wavelengths of approximately 795 nm and approximately 1324 nm in response to excitation by received light having wavelengths of approximately 780 nm and approximately 1367 nm. Alternatively or additionally, a two-photon resonance in an ⁸⁷Rb vapor may be used to generate photon pairs having wavelengths of approximately 1367 nm and 780 nm, 1476 nm and 795 nm, and/or 1529 nm and 780 nm, providing a flexible photon source that may be used to generate a spectrum of wavelengths in the NIR, O, C, and/or S bands. These particular bands have a wide range of applications across quantum communications and computation. For example, the wavelengths 1324 nm, 1476 nm, and 1529 nm each respectively correspond to O, S, and C telecom bands, and are suitable wavelengths for optical fiber communications over large distances. Additionally, the wavelengths 795 nm and 780 nm are commonly used for quantum buffers and sensors.

This illustrative transition cycle offers few pathways for photons to spontaneously decay to the ground state, providing a higher rate of entanglement and fewer output uncorrelated photons. It should be appreciated that other similar two-photon resonances may exist in other isotopes of rubidium or other atomic systems. As additional examples, potential wavelengths of photon pairs that may be generated in ⁸⁷Rb and ¹³³Cs systems are provided in Tables 1 and 2, respectively. These additional illustrative wavelengths may be used to interface with some Rydberg and ion technologies such as neutral quantum computers and sensors.

TABLE 1
Wavelengths of photon pairs that can be generated from atomic transitions in ⁸⁷Rb.

| | Transitions between the | | Transitions between the | | Transitions between the | | Transitions between the | |
|---|---|---|---|---|---|---|---|---|
| | D₁ line and nS states | | D₂ line and nS states | | D₁ line and nD_{3/2} states | | D₂ line and nD_{3/2} states | |
| | First | Second | First | Second | First | Second | First | Second |
| | Wave- | Wave- | Wave- | Wave- | Wave- | Wave- | Wave- | Wave- |
| | length | length | length | length | length | length | length | length |
| n | (nm) | (nm) | (nm) | (nm) | (nm) | (nm) | (nm) | (nm) |
| 4 | | | | | 1475.64 | | 1529.26 | |
| 5 | | | | | 1475.64 | 762.10 | 1529.26 | 776.16 |
| 6 | 1323.88 | | 1366.87 | | 1475.64 | 620.80 | 1529.26 | 630.10 |
| 7 | 1323.88 | 728.20 | 1366.87 | 741.02 | 1475.64 | 564.93 | 1529.26 | 572.62 |
| 8 | 1323.88 | 607.23 | 1366.87 | 616.12 | 1475.64 | 536.42 | 1529.26 | 543.35 |
| 9 | 1323.88 | 558.03 | 1366.87 | 565.53 | 1475.64 | 519.68 | 1529.26 | 526.17 |
| 10 | 1323.88 | 532.38 | 1366.87 | 539.21 | 1475.64 | 508.94 | 1529.26 | 515.17 |
| 11 | 1323.88 | 517.11 | 1366.87 | 523.54 | 1475.64 | 501.62 | 1529.26 | 507.67 |
| 12 | 1323.88 | 507.20 | 1366.87 | 513.39 | 1475.64 | 496.38 | 1529.26 | 502.31 |
| 13 | 1323.88 | 500.38 | 1366.87 | 506.40 | 1475.64 | 492.51 | 1529.26 | 498.34 |
| 14 | 1323.88 | 495.47 | 1366.87 | 501.38 | 1475.64 | 489.56 | 1529.26 | 495.32 |
| 15 | 1323.88 | 491.82 | 1366.87 | 497.63 | 1475.64 | 487.25 | 1529.26 | 492.96 |
| 16 | 1323.88 | 489.02 | 1366.87 | 494.77 | 1475.64 | 485.42 | 1529.26 | 491.08 |
| 17 | 1323.88 | 486.83 | 1366.87 | 492.52 | 1475.64 | 483.93 | 1529.26 | 489.56 |
| 18 | 1323.88 | 485.073 | 1366.87 | 490.73 | 1475.64 | 482.71 | 1529.26 | 488.31 |
| 19 | 1323.88 | 483.65 | 1366.87 | 489.27 | 1475.64 | 481.70 | 1529.26 | 487.28 |
| 20 | 1323.88 | 482.48 | 1366.87 | 488.08 | 1475.64 | 480.85 | 1529.26 | 486.41 |
| n → ∞ | 1323.88 | 474 | 1366.87 | 479 | 1475.64 | 474 | 1529.26 | 479 |

TABLE 2
Wavelengths of photon pairs that can be generated from atomic transitions in ¹³³Cs.

| | Transitions between the | | Transitions between the | | Transitions between the | | Transitions between the | |
|---|---|---|---|---|---|---|---|---|
| | D₁ line and nS states | | D₂ line and nS states | | D₁ line and nD_{3/2} states | | D₂ line and nD_{3/2} states | |
| | First | Second | First | Second | First | Second | First | Second |
| | Wave- | Wave- | Wave- | Wave- | Wave- | Wave- | Wave- | Wave- |
| | length | length | length | length | length | length | length | length |
| n | (nm) | (nm) | (nm) | (nm) | (nm) | (nm) | (nm) | (nm) |
| 5 | | | | | 3011.15 | | 3614.09 | |
| 6 | | | | | 3011.15 | 876.38 | 3614.09 | 921.11 |
| 7 | 1359.20 | | 1469.89 | | 3011.15 | 672.51 | 3614.09 | 698.54 |
| 8 | 1359.20 | 761.10 | 1469.89 | 794.61 | 3011.15 | 601.22 | 3614.09 | 621.93 |
| 9 | 1359.20 | 635.63 | 1469.89 | 658.83 | 3011.15 | 566.56 | 3614.09 | 584.92 |
| 10 | 1359.20 | 584.05 | 1469.89 | 603.58 | 3011.15 | 546.75 | 3614.09 | 563.83 |
| 11 | 1359.20 | 557.00 | 1469.89 | 574.73 | 3011.15 | 534.24 | 3614.09 | 550.54 |
| 12 | 1359.20 | 540.82 | 1469.89 | 557.52 | 3011.15 | 525.80 | 3614.09 | 541.58 |
| 13 | 1359.20 | 530.29 | 1469.89 | 546.34 | 3011.15 | 519.82 | 3614.09 | 535.23 |
| 14 | 1359.20 | 523.03 | 1469.89 | 538.64 | 3011.15 | 515.41 | 3614.09 | 530.56 |
| 15 | 1359.20 | 517.79 | 1469.89 | 533.09 | 3011.15 | 512.07 | 3614.09 | 527.02 |
| 16 | 1359.20 | 513.88 | 1469.89 | 528.94 | 3011.15 | 509.47 | 3614.09 | 524.27 |
| 17 | 1359.20 | 510.89 | 1469.89 | 525.77 | 3011.15 | 507.41 | 3614.09 | 522.08 |
| 18 | 1359.20 | 508.54 | 1469.89 | 523.28 | 3011.15 | 505.74 | 3614.09 | 520.32 |
| 19 | 1359.20 | 506.66 | 1469.89 | 521.29 | 3011.15 | 504.38 | 3614.09 | 518.88 |
| 20 | 1359.20 | 505.13 | 1469.89 | 519.68 | 3011.15 | 503.25 | 3614.09 | 517.68 |
| n → ∞ | 1359.20 | 494 | 1469.89 | 508 | 3011.15 | 494 | 3614.09 | 508 |

The second entanglement source 306 is a second photon source configured to generate a second pair of entangled photons, during the operation of system 300. The second pair of entangled photons includes a third and a fourth photon. The second photon source is configured to output the third photon to the encryption channel and to output the fourth photon to a bell state evaluator. In some embodiments, the second entanglement source 306 is configured in the same way as the first entanglement source 302. For example, the second entanglement source 306 may include the same atomic gas vapor and may be configured to produce the same wavelengths as the first entanglement source. In some embodiments, the second entanglement source 306 is configured in a different way than the first entanglement source 302. For example, the second entanglement source may be an atomic gas vapor entanglement source which is configured to generate different wavelengths than the first entanglement source. The first entanglement source may be configured to generate an entangled pair having a first photon in the C-band and a second photon in the Near IR range, while the second entanglement source may be configured to generate an entangled pair having a first photon in the O band and a second photon in the NearIR range.

The first time gate 304 is configured to, in response to receiving the second photon, cause third photons generated by the second photon source or the encoded photon generated by the optical modulator to be output into the encryption channel. In some embodiments, the first time gate may transmit trigger signals to the second entanglement source 306 and the data transmission source 308 such that the trigger signals control one of the two sources to transmit light to the encryption channel when triggered. In some embodiments, the first time gate may be an optical switch configured to receive photons from second entanglement source 306 at a first input of the switch and further configured to receive photons from data transmission source 308 at a second input of the switch. The optical switch, in response to receiving the second photon from first entanglement source 302, causes either the photon from the entanglement source 306 or the photon from the data transmission source 308 to be output from the optical switch to the encryption channel 310. For example, when the second photon has a first polarization, a photon from the second entanglement source 306 may be output from the optical switch. By contrast, when the second photon has a second polarization, the second polarization being orthogonal to the first polarization, a photon from the data transmission source 308 may be output from the optical switch.

In some embodiments, the encryption channel 310 is an optical fiber configured to transmit light having a telecom wavelength, as described herein.

Communication node 303 includes first entanglement detector 314, second time gate 316, second entanglement detector 318, and data transmission detector 320. First entanglement detector 314 includes a photon detector configured to receive an entangled photon from the encryption channel 310 and to generate a gating signal, to control the second time gate 316. In some embodiments, first entanglement detector 314 detects a polarization state of the received photon and generates the gating signal based on the detected polarization state. For example, detecting a first polarization state may generate a first gating value and detecting a second polarization state, orthogonal to the first polarization state, may generate a second gating value.

The second time gate 316 includes two or more outputs and is configured to control which of the two or more outputs to send a signal received from the optical fiber at an input of the time gate. In some embodiments, the gating signal received from the first entanglement detector 314 indicates whether the input received by the second time gate 316 from the optical fiber is an entangled photon which should be directed through a first output to the second entanglement detector 318 or an encoded photon which should be directed through a second output to the data transmission detector 320.

The second entanglement detector 318 is configured to determine an entangled state of a photon received from the second time gate. In some embodiments, the second entanglement detector 318 determines a polarization state of the photon received from the second time gate. Once the polarization state has been determined, the polarization state is compared to the polarization state determined for the corresponding entangled photon, produced by the second entanglement source 306, to determine the degree of entanglement between the photons and whether the encryption channel 310 is secure. To facilitate communication of the measured polarization states, a non-quantum encrypted communication channel 312 is included to communicatively couple the first communication node 301 to the second communication node 303. For example, the polarization state detected by the second entanglement detector 318 is communicated back to communication node 301 through communication channel 312 to be compared with the polarization state for the corresponding entangled photon.

In some embodiments, first entanglement detector 314 communicates a detected polarization state of an entangled photon generated by the first entanglement source, through communication channel 312, to the first communication node 301 for determination of the degree of entanglement between the photons of the photon pair generated by the first entanglement source.

The data transmission detector 320 is configured to decode data signals from the photons encoded with data by the data transmission source 308, when the second time gate 316 directs the encoded photons to the data transmission detector 320. Data transmission detector 320 is a photon detector. Any suitable photon detector that can detect photons at the appropriate telecom wavelength of the transmitted photon may be used, as aspects of technology described herein are not limited in this respect.

FIG. 4 illustrates a block diagram of an alternative configuration of a quantum encryption system 400 for sending and receiving quantum encrypted signals, in accordance with some embodiments of the technology described herein. Alternative configuration of quantum encryption system 400 includes similar components to that of quantum encryption system 300, described above in connection with FIG. 3. Relative to the configuration in FIG. 3, quantum encryption system 400 is configured for bidirectional communication, e.g., the sending and receiving of quantum encrypted signals. To provide for bidirectional communication, at least one entanglement source is located in each communication node. Communication node 401 includes first entanglement detector 402, first entanglement source 404, first data transmission source 406, first transmission detector 408, and first time gate 410. Communication node 403 includes second entanglement detector 418, second entanglement source 422, second data transmission source 424, second data transmission detector 426, and second time date 420.

Encryption channel 412 transmits signals from the first communication node 401 to the second communication node 403. Encryption channel 414 transmits signals from the second communication node 403 to the first communication node 401. Communication line 416 provides for non-quantum encrypted communication between the communication nodes.

When being used for transmitting quantum encrypted signals from communication node 401, first entanglement detector 402 is used to generate a gating signal. First entanglement detector 402 includes a photon detector configured to receive an entangled photon from the encryption channel 414, generated by second entanglement source 422, and to generate a gating signal to control the first time gate 410. In some embodiments, first entanglement detector 402 detects a polarization state of the received photon and generates the gating signal based on the detected polarization state.

First time gate 410, when being used for transmitting quantum encrypted signals from communication node 401, receives the gating signal from first entanglement detector 402 and is configured to cause an entangled photon generated by the first entanglement source or the encoded photon generated by the first data transmission source to be output to the encryption channel. In this way, the first time gate 410 may operate in the same was as time gate 304 by using an optical switch to interleave outputs from the first entanglement source 404 and the first data transmission source 406 to transmit through encryption channel 412, as described herein.

First entanglement source 404 may be in the same configuration as describe above for the second entanglement source 306. Accordingly, first entanglement source 404 may operate in the same way, as second entanglement source 306, to provide an entangled photon for encrypting the data transmission through the first time gate 410 and encryption channel 412.

First data transmission source 406 may be in the same configuration as described above for data transmission source 308. Accordingly, first data transmission source 406 may operate in the same way, as data transmission source 308, to provide an encoded photon for transmitting data through the first time gate 410 and encryption channel 412.

When communication node 401 is being used for transmitting quantum encrypted signals, second time gate 420 receives the quantum encrypted signal through encryption channel 412 and receives a gating signal from second entanglement source 422. The gating signal from second entanglement source 422 causing the second time gate to direct the received signal either to second entanglement detector 418 or to second data transmission detector 426.

Having discussed transmission of quantum encrypted signals from communication node 401, the receiving of quantum encrypted signals by communication node 401, from communication node 403 operates similarly. When communication node 401 is being used to receive quantum encrypted signals, first entanglement source 404 generates an entangled pair of photons, the first entangled photon is used for transmitting through encryption channel 412 to be used to generate a gating signal for second time gate 420, and the second entangled photon is used as a gating signal for the first time gate 410 such that the first time gate 410 properly directs photons received through encryption channel 414 to the appropriate detector, either first entanglement detector 402 or first data transmission detector 408.

When communication node 401 is being used to receive quantum encrypted signals, second entanglement detector 418, of the second communication node 403, receives an entangled photon from the first entanglement source 404 through encryption channel 412. In response to receiving an entangled photon, second entanglement detector generates a gating signal for the second time gate 420 to control whether an entangled photon from the second entanglement source 422 or an encoded photon from the second data transmission source 424 is transmitted through the outgoing output of the second time gate 420 through encryption channel 414.

When the quantum encrypted transmission is received by communication node 401, the first time gate 410 directs the received photons to either the first entanglement detector 402 or the first data transmission detector 408 in accordance with the gating signal generated by first engagement source 404 when generating the entangled pair, the first entangled photon of which was transmitted to be used as a gating signal at the second communication node 403.

Encryption channel 412 and encryption channel 414 may be configured as optical fibers as described herein. Similarly, communication line 416 is used to communicate detected Bell state values between the communication nodes to ensure the encryption channel remains secure.

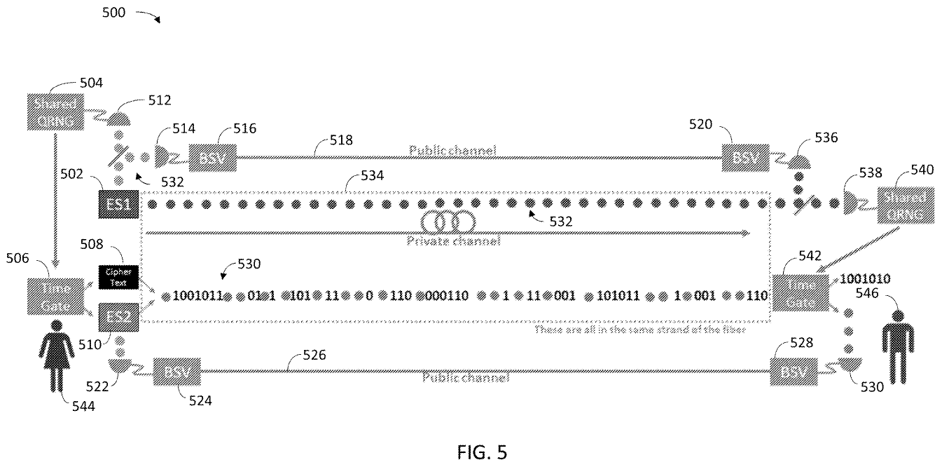

FIG. 5 illustrates a schematic diagram of a quantum encryption system 500 for sending and receiving quantum encrypted signals, in accordance with some embodiments of the technology described herein. Quantum encryption system 500 includes a first entanglement source 502, shared quantum random number generator 504 and 540, time gate 506 and 542, data transmission source 508, a second entanglement source 510, Bell state value detector 516, BSV 520, BSV 524, BSV 528, first detector 512 associated with the shared QRNG 504, second detector 514 associated with the BSV 516, encryption channel 534, first public channel 518, second public channel 526, third detector 522 associated with BSV 524, fourth detector 530 associated with BSV 528, fifth detector 536 associated with BSV 520, and sixth detector 538 associated with shared QRNG 540, time gate 542, quantum encrypted transmission 540, and entangled photon 534.

A first user 544 may send secure messages to second user 546 using system 500. To send a quantum encrypted transmission, first entanglement source 502 generates entangled photons including a first entangled photon 532 having a first wavelength and a second entangled photon having a second wavelength, the second wavelength being different than the first wavelength. The second entangled photon is received by detector 512 associated with the shared quantum random number generator. The detector 512 is configured to detect a polarization state associated with the entangled photon 532.

The shared QRNG 504 generates a random number based on the polarization detected by the detector 512. For example, the QRNG may determine a binary value at random, e.g., randomly determining “0” or “1”. The QRNG may leverage the random nature of the entanglement process to generate the random number. The polarization of the entangled photon is random, accordingly, by assigning one of the random numbers to each of the respective polarization states, the QNRG can produce random numbers based on the polarization of the entangled photon 532. For example, photons having a first polarization may result in the QRNG generating a value “0” and photons having a second polarization may result in the QRNG generating a value “1”, where the second polarization is orthogonal to the first polarization.

The random numbers generated by the shared QRNG 504 are provided to time gate 506. The time gate may select light from a first input to be output from the time gate to an encryption channel 534 in response to receiving a first random number and may select light from a second input to be output from the time gate in response to receiving a second random number. For example, a “0” may cause the time gate 506 to transmit an encoded photon from data encoder 508 to the encryption channel. A “1” may cause the time gate 506 to transmit an entangled photon from the second entanglement source 510 to the encryption channel. As a result, encrypted transmission 530 is generated having interleaved photons, randomly determined based on a state of the entanglement source.

To decrypt the transmission, time gate 542 receives a gating signal from shared QRNG 540. Shared QRNG 540 receives the first entangled photon 534. As the first entangled photon and the second entangled photon have a fixed polarization relationship, using the second entangled photon to encode the transmission signal using time gate 506 and using the first entangled photon to decode the transmission signal using time gate 542 enables the separation of the randomly interleaved photons to the appropriate detectors. The entangled photons are directed to detector 530 in connection with BSV 528 such that the degree of entanglement between the third and fourth entangled photons can be determined to confirm whether the photons remain entangled, and by extension, if the encryption channel is secure. BSV 524 is configured to detect the Near IR entangled photon generated by the second entanglement source 510 and the BSV 528 that detects the transmitted entangled photon are communicatively coupled through a non-quantum encrypted channel 526 for sending the polarization measurements executed at the respective detectors to be used to determine the degree of entanglement.

Similarly, to confirm the security of the gating signal produced from the first entanglement source 502, detectors 514 associated with BSV 516 and detector 536 associated with BSV 520 are used to measure the polarization states of the second entangled photon 532 and the first entangled photon 532, respectively. BSV 516 and BSV 520 are communicatively coupled through non-quantum encrypted channel 518 for sending the polarization measurements executed at the respective detectors to be used to determine the degree of entanglement.

In addition to generating a third entangled photon, the second entanglement source generates a fourth entanglement photon that is received by detector 522 for determining a Bell state value of the third entangled photon.

In the illustrated embodiment of FIG. 5, the first entangled photon has a wavelength in the C band and the second entangled photon has a wavelength in the Near IR. The third entangled photon has a wavelength in the O band and the fourth entangled photon has a wavelength in the Near IR.

In some embodiments, the interleaving between entangled photons and data encoded photons includes alternating between each data encoded packet, or even subpacket, with an entangled photon. In some embodiments, chunks of data encoded in sequential photons may be bracketed on each side by an entangled photon.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The use of “coupled” or “connected” is meant to refer to elements, or signals, that are either directly linked to one another or are linked through intermediate components. Elements that are not “coupled” or “connected” are “decoupled” or “disconnected.”

The use of “between” in a coupled signal chain is not meant to require a particular direction of signal flow in the signal chain unless stated otherwise. For instance, where element B is described as coupled between elements A and C in a signal chain, signals may flow from element A to element C through element B and/or from element C to element A through element B unless stated otherwise.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A system for encrypting a data stream, the system comprising:
an encryption channel comprising an optical fiber;
a first photon source configured to, during operation of the system, generate a first pair of entangled photons comprising a first photon and a second photon, wherein the first photon source is configured to output the first photon to the encryption channel and to output the second photon to a time gate;
a second photon source configured to, during operation of the system, generate a second pair of entangled photons comprising a third photon and a fourth photon, wherein the second photon source is configured to output the third photon to the encryption channel and to output the fourth photon to a bell state evaluator;
an optical modulator configured to modulate a photon to generate an encoded photon for transmission of the data stream; and
the time gate is configured to, responsive to receiving the second photon, cause the third photon or the encoded photon for the transmission of the data stream to be output to the encryption channel.

2. The system of claim 1, wherein the optical fiber of the encryption channel is configured to transmit light having a telecom wavelength.

3. The system of claim 2, wherein the optical fiber of the encryption channel is configured for bidirectional transmission.

4. The system of claim 2, wherein the optical fiber of the encryption channel is a first optical fiber that is configured for unidirectional transmission and wherein the encryption channel further comprises one or more optical fibers, the one or more optical fibers comprising a second optical fiber that is configured for unidirectional transmission is a direction opposite to the direction of transmission of the first optical fiber.

5. The system of claim 1, wherein the time gate is an optical switch.

6. The system of claim 1, wherein the first entanglement light source is an atomic vapor cell-based entanglement source configured to produce a pair of entangled photons having different wavelengths.

7. The system of claim 6, wherein a first entangled photon of the pair of entangled photons has a wavelength between 1200 and 1600 nm, and the second entangled photon of the pair of entangled photons has a wavelength between 700 and 900 nm.

8. The system of claim 7, wherein the first entangled photon has a wavelength of 1529 nm and the second entangled photon has a wavelength of 780 nm.

9. The system of claim 1, wherein a quantum random number generator is used to generate the gating signal to control the time gate.

10. The system of claim 9, wherein the quantum random number generator is configured to detect light having a polarization corresponding to the polarization state of the second entangled photon.

11. The system of claim 10, wherein the quantum random number generator is configured to transmit a control signal to the time gate based on the polarization state of the second entangled photon.

12. The system of claim 11, wherein the time gate is configured to transmit light received from the optical modulator in response to the quantum random number generator detecting an entangled photon having a first polarization state, and the time gate is configured to transmit light received from the second entanglement source in response to the quantum random number generator detecting an entangled photon having a second polarization state where the second polarization state is orthogonal to the first polarization state.

13. The system of claim 1, wherein the first entanglement light source is configured to generate a first entangled photon and a second entangled photon, the first entangled photon having a wavelength in the C-band, and the second entanglement light source is configured to generate a third entangled photon and a fourth entangled photon, the third entangled photon having a wavelength in the O-band.

14. The system of claim 13, wherein the optical modulator is configured to modulate light having a same wavelength as the third entangled photon.

15. A system for reading an encrypted signal from a telecom data stream, the system comprising:
an encryption channel comprising an optical fiber;
a first photon detector configured to receive a first entangled photon to generate a gating signal to control a time gate;
the time gate comprising two or more outputs, and the time gate being configured to control which one of the two or more outputs to send a signal received from the optical fiber at an input of the time gate;
a second photon detector configured to receive output from a first output of the time gate and to determine an entanglement state of the photon; and
a third photon detector configured to receive output from a second output of the time gate and to detect photons corresponding to a data stream.

16. The system of claim 15, wherein the optical fiber of the encryption channel is configured to transmit light having a telecom wavelength.

17. The system of claim 16, wherein the optical fiber of the encryption channel is configured for bidirectional transmission.

18. The system of claim 16, wherein the optical fiber of the encryption channel is a first optical fiber that is configured for unidirectional transmission and wherein the encryption channel further comprises one or more optical fibers, the one or more optical fibers comprising a second optical fiber that is configured for unidirectional transmission is a direction opposite to the direction of transmission of the first optical fiber.

19. The system of claim 15, wherein the time gate is an optical switch.

20. The system of claim 15, wherein the first photon detector is coupled to a quantum random number generator that is configured to generate the gating signal to control the time gate based at least in part on the output of the photon detector.

21. The system of claim 20, wherein the first photon detector is configured to detect light having a polarization corresponding to the polarization state of the first entangled photon.

22. The system of claim 21, wherein the quantum random number generator is configured to transmit a control signal to the time gate based on the polarization state of the second entangled photon.

23. The system of claim 22, wherein the time gate is configured to transmit light received from the optical fiber to the second photon detector in response to the output of the quantum random number generator detecting an entangled photon having a first polarization state, and the time gate is configured to transmit light received from the optical fiber to the third photon detector in response to the quantum random number generator detecting an entangled photon having a second polarization state where the second polarization state is orthogonal to the first polarization state.

24. The system of claim 15, further comprising an unencrypted channel.

25. The system of claim 24, wherein the output of the second photon detector and the unencrypted channel are configured for verifying the security of the encrypted channel.

26. A system for processing encrypted signals in a telecom data stream, the system comprising:
an encryption channel comprising an optical fiber;
a time gate comprising two or more inputs and two or more outputs to direct incoming and outgoing photons;
an optical modulator configured to modulate photons corresponding to a data stream to generate encoded photons for transmission;
a first photon source configured to generate a first pair of entangled photons, the first entanglement light source being configured to provide a first photon, of the first pair of entangled photons, to the encryption channel and to provide a second photon, of the first pair of entangled photons, to a bell state evaluator; and
a first photon detector configured to receive a first entangled photon to generate a gating signal to control the time gate.

27. The system of claim 26, wherein the optical fiber of the encryption channel is configured to transmit light having a telecom wavelength.

28. The system of claim 27, wherein the optical fiber of the encryption channel is configured for bidirectional transmission.

29. The system of claim 27, wherein the optical fiber of the encryption channel is a first optical fiber that is configured for unidirectional transmission and wherein the encryption channel further comprises one or more optical fibers, the one or more optical fibers comprising a second optical fiber that is configured for unidirectional transmission is a direction opposite to the direction of transmission of the first optical fiber.

30. The system of claim 26, wherein the time gate is an optical switch.

31. The system of claim 26, wherein the first photon detector is configured to detect light having a polarization corresponding to the polarization state of the first entangled photon.

32. The system of claim 31, wherein the first photon detector is configured with a random number generator that is configured to transmit a control signal to the time gate based on the polarization state of the first entangled photon.

33. The system of claim 32, wherein the time gate is configured to transmit light received from the optical modulator in response to the quantum random number generator detecting an entangled photon having a first polarization state, and the time gate is configured to transmit light received from the second entanglement source in response to the quantum random number generator detecting an entangled photon having a second polarization state where the second polarization state is orthogonal to the first polarization state.

34. The system of claim 26, wherein the first photon source is configured to generate at least one entangled photon having a same wavelength as photons produced by the optical modulator.

35. A method for encrypting telecom optical signals using optical qubits for secure communication transmission, the method comprising:
generating a gating signal based on a coherent photon received by a detector of a quantum random number generator;
generating a first bichromatic entangled pair comprising a first photon with a first wavelength configured for telecom transmission and a second photon having a second wavelength that is different than the first wavelength;
selecting whether to transmit an optical source encoded for data transmission or the first photon through an encryption channel, the selection being based on the random number; and
detecting a state of the second photon.

36. The method of claim 35, wherein the encryption channel is an optical fiber configured to transmit light having a telecom wavelength.

37. The method of claim 36, wherein selecting whether to transmit the optical source encoded for data transmission or the first photon through the encryption channel comprises controlling which input of an optical switch is output by the switch.

38. The method of claim 35, wherein generating the first bichromatic entanglement pair comprises generating the entangled pair of photons using a two-photon pumping of an atomic vapor cell.

39. The method of claim 35, further comprising, prior to generating the gating signal, generating the coherent photon by generating a second bichromatic entanglement pair.

40. The method of claim 35, wherein detecting the state of the second photon comprises detecting a polarization state of the second photon.

41. The method of claim 40, further comprising:
receiving, through a non-quantum encrypted channel, an indication of the polarization state of the first photon; and
determining whether the polarization state of the first photon and the polarization state of the second photon indicate that the first photon and the second photon remained entangled after transmission of the first photon through the encryption channel.

42. The method of claim 35, further comprising:
receiving, through a non-quantum encrypted channel, an indication of when the first photon was received after transmission through the encryption channel;
determining whether a transmitted photon is missing based on the received indication of when the first photon was received after transmission through the encryption channel and an indication of when the first photon was transmitted through the encryption channel.

43. A method for decoding an optical signal that is encoded with optical qubits to receive a data stream, the method comprising:
generating a gating signal based on a coherent photon received by a detector of a quantum random number generator;
selecting whether to transmit a received photon to a first optical detector or a second optical detector based on the random number;
detecting a photon corresponding to an entangled photon received at the first optical detector;
determining an entanglement state of the photon received at the first optical detector; and
detecting a second photon corresponding to a data stream received at the second optical detector.

44. The method of claim 43, wherein the coherent photon received by the detector is received from an encryption channel, and wherein the encryption channel an optical fiber configured to transmit light having a telecom wavelength.

45. The method of claim 43, wherein selecting whether to transmit the received photon to the first optical detector or to the second optical detector comprises controlling which output of an optical switch to transmit the received photon through.

46. The method of claim 43, wherein detecting the photon corresponding to the entangled photon comprises detecting a polarization state corresponding to the polarization state of the photon received at the first optical detector.

47. The method of claim 46, further comprising transmitting, through a non-quantum encrypted channel, an indication of the polarization state of the photon received at the first optical detector.

48. The method of claim 43, further comprising transmitting, through a non-quantum encrypted channel an indication of when the photon was received at the first optical detector.
